(19) United States
(12) Patent Application Publication
(10) Pub. No.: US 2023/0375068 A1
(43) Pub. Date: Nov. 23, 2023

(54) DAMPING VALVE DEVICE WITH ADJUSTABLE STOP

(71) Applicant: ZF FRIEDRICHSHAFEN AG, Friedrichshafen (DE)

(72) Inventors: Hartmut RÖLLEKE, Kircheib (DE); Mathias BALENSIEFER, Eitorf (DE); Jörg RÕSSELER, Ruppichteroth (DE); Aleksandar KNEZEVIC, Eitorf (DE)

(21) Appl. No.: 18/199,186

(22) Filed: May 18, 2023

(30) Foreign Application Priority Data
May 19, 2022 (DE) 10 2022 204 983.7

(51) Int. Cl. F16F 9/348; F16F 9/32; F16F 9/19

(52) U.S. Cl. CPC F16F 9/3487; F16F 9/3482; F16F 9/3221; F16F 9/19; F16F 9/3214; F16F 2228/004

(57) ABSTRACT

Damping valve device including a valve carrier having a circumferential annular groove in which a valve element, which can be changed in terms of diameter, forms a throttle point together with a flow guiding surface. The throttle point transitions from a through-flow position into a throttled position as a function of the flow rate of the damping medium, and at the same time the maximum widened position of the valve element which is determined by a stop is limited, the stop being designed to be adjustable.

### BACKGROUND OF INVENTION

### 1. Field of the Invention

The disclosure relates to a damping valve device.

### 2. Description of Related Art

DE 10 2016 210 790 A1 describes a damping valve device with a valve element that can be changed in terms of diameter. Two principles are disclosed for limiting the widening movement of the valve element. Either the valve element can bear against the internal wall of a working cylinder so that the internal wall represents a stop, or there is the option of a force-controlled stop via a restoring spring which acts counter to the widening movement.

A damping valve device is disclosed in DE 10 2019 215 556 A1 on the basis of DE 10 2016 210 790 A1, in which a stop, as part of a valve carrier in which the valve element is guided, limits the widening movement.

### SUMMARY OF THE INVENTION

An object of one aspect of the present disclosure is to solve the problem of maintaining the minimum throttle cross section of the damping valve device.

Maintaining and reaching the maximum damping force of the damping valve device depends on the accuracy of the throttle cross section of the damping valve device. A first solution could consist in increasing the dimensional accuracy of the components which determine the throttle cross section. However, this could be associated with a significant increase in the production costs of the damping valve device.

One aspect of the disclosure is a stop designed to be adjustable.

Existing production deviations of the damping valve device are compensated via the adjustability of the stop. As a result, the previous production tolerances can remain or even be increased, so that the adjustability of the stop does not necessarily have to lead to a cost increase in the damping valve device.

An additional or alternative aspect is that the stop is oriented as a function of the radial position of a piston on a piston rod, the damping valve device also being at least indirectly fastened thereto. Tests have shown that an eccentric position of the piston relative to the damping valve device influences the cross section of the throttle since the position of the piston rod in a vibration damper is determined by a piston rod guidance and the piston. The radial position of the piston rod, however, also determines the cross section of the throttle when the damping valve device is fastened to the piston rod.

A particularly simple aspect of the disclosure is provided if the adjustable stop is formed by an edge on the carrier side.

Preferably, the stop is configured in a segment-like manner. In the case of a segment-like stop, the individual segments can be variably adjusted and thus the position of the valve element can be more easily centred relative to the piston.

In one aspect of the disclosure, the stop is designed in one piece with a cover of the valve carrier.

Alternatively, the stop can be fastened to the piston. Thus the position of the valve element is also adjusted during the mounting of the piston.

One aspect of the disclosure can consist, for example, in that the stop is formed by a sleeve which is supported on the piston.

In a one aspect of the disclosure, the stop is formed by an axially adjustable stop sleeve. The maximum widened position of the valve element is determined via the overlap of the stop with the annular groove. The stop can have, for example, a stepped profile on a stop surface for the valve element.

To this end, at least one contact surface region of the valve element with the adjustable stop has a conical surface.

A particularly fine adjustment function can be achieved by the stop sleeve being designed as a screw sleeve.

A method for adjusting the stop is designed to be very simple by the stop being adjusted as a function of a defined diameter of the valve element, by the valve carrier being at least partially plastically deformed by a re-shaping tool.

Optionally, before the start of the re-shaping process the annular groove can have a height which is greater than the overall height of the valve element. This option permits the use of a one-piece valve carrier in which, in the maximum opened stop position, the valve element is inserted into the annular groove and then the stop is adjusted and thus the valve element is captively held in the annular groove.

A further adjusting parameter of the stop is achieved by the re-shaping tool being supported on the piston for adjusting the stop. Thus the valve element, and as a result also the damping valve device, are functionally oriented relative to the radial piston position.

### BRIEF DESCRIPTION OF THE DRAWINGS

The disclosure is to be explained in more detail by way of the following description of the figures.

In the figures:

FIG. 1 is a detail of a vibration damper;

FIG. 2 is a cross section through a damping valve device according to FIG. 1;

FIG. 3 is a plan view of FIG. 2;

FIG. 4 is a damping valve device;

FIG. 5 is a detail of a vibration damper; and

FIG. 6 is a cross section through a damping valve device.

### DETAILED DESCRIPTION OF THE PRESENTLY PREFERRED EMBODIMENTS

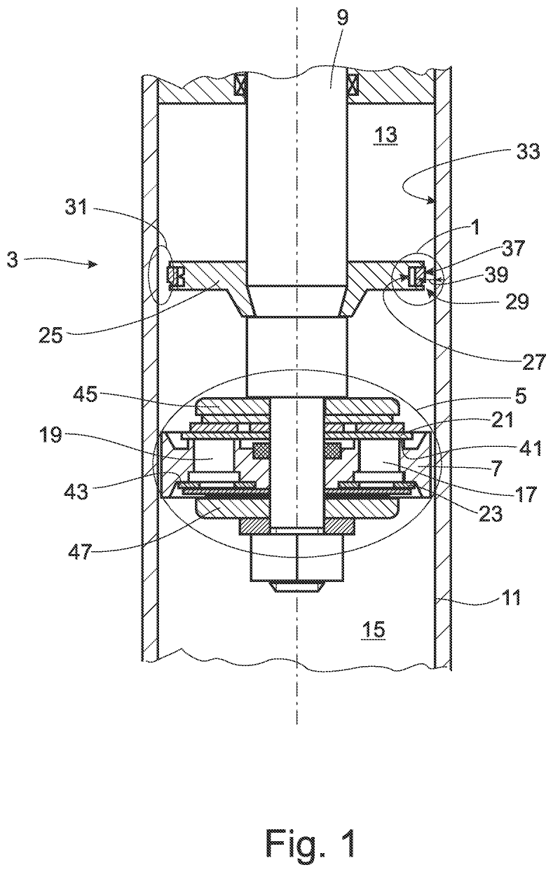

FIG. 1 shows a damping valve device 1 for a vibration damper 3 of any design, only shown in a detail. In addition to the damping valve device 1, the vibration damper 3 comprises a first damping valve 5 with a damping valve body which is designed as a piston 7 and which is fastened to a piston rod 9.

The damping valve body 7 subdivides a cylinder 11 of the vibration damper into a working chamber 13 facing the piston rod and a working chamber 15 facing away from the piston rod, both working chambers being filled with damping medium. Through-channels 17; 19 are designed for one respective through-flow direction on different pitch circles in the damping valve body 7. The design of the through-channels 17; 19 is to be regarded only by way of example. An outlet side of the through-channels 17; 19 is at least partially covered by at least one valve disc 21; 23.

By way of example, a valve carrier 25 of the damping valve device 1 is directly fixed to the piston rod 9.

The valve carrier 25 has a circumferential annular groove 27 in which a valve element 29, which can be changed in terms of diameter, is guided. This valve element 29 is radially movable and forms a valve body for a throttle point 31 as part of the damping valve device 1. The valve element 29 forms the throttle point 31 with an internal wall of the cylinder 11, wherein the internal wall represents a flow guiding surface 33.

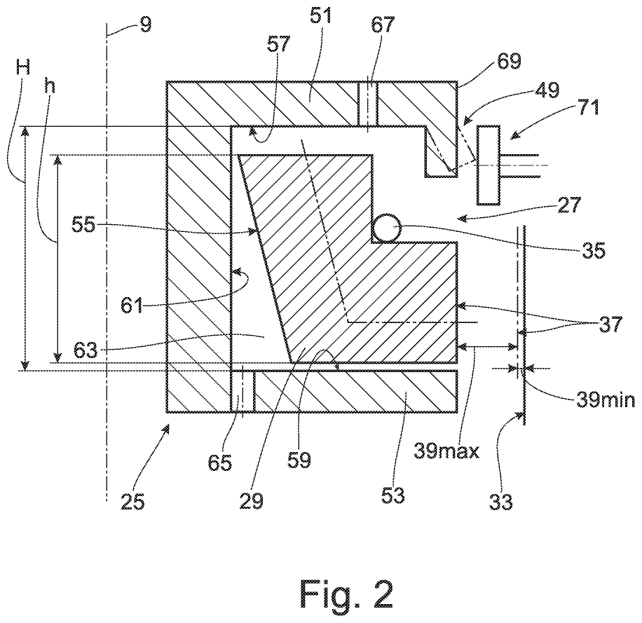

The valve element 29 is provided with a restoring spring 35, as shown enlarged in FIG. 2, for example. A variable throttle cross section 39, which generates an additional damping force, is present between the flow guiding surface 33 and an outer side surface 37 of the valve element 29.

With a piston rod velocity in a first operating range, for example less than 1 m/s, the throttle point 31 is fully opened. The damping force is then generated only by the through-channels 17; 19 in combination with the valve discs 21; 23. When there is an incident flow onto the valve discs 21; 23, the valve discs 21; 23 lift away from their valve seat surface 41; 43. The lifting-away movement is limited in each case by a support disc 45; 47.

In a second operating range, with a piston rod velocity which is greater than the limit velocity of the first operating range, i.e. greater than the 1 m/s specified by way of example, the valve element 29 transitions into a throttled position with the throttle cross section 39 min and at the same time performs a closing movement in the direction of the flow guiding surface 33. A negative pressure is formed due to the high flow rate of the damping medium in the throttle point 31, which is shaped as an annular gap, which leads to a radial widening of the valve element 29. However, so that a blockage of the throttle point 31 can never occur, the defined minimum through-cross section can be maintained, for example, by the restoring spring 35. In the present embodiment, to this end the valve carrier 25 has a stop 49 on a cover disc 51; 53 of the valve carrier 25.

FIG. 2 shows a detailed view of the damping valve device 1 according to FIG. 1. In the enlargement it can be identified that the annular groove 27 forms annular groove side surfaces 57; 59 of the cover discs 51; 53 with an inner side surface 55 of the valve element 29, and forms a pressure chamber 63 with an annular groove bottom surface 61, the pressure chamber being connected via at least one inflow opening 65 and one outflow opening 67 to the working chamber of the vibration damper 3. The pressure chamber 63 brings about a radially outwardly oriented force component which widens the valve element 29 and which assists the negative pressure situation prevailing at the throttle point 31. The functional terms “inflow opening” and “outflow opening” can be expediently exchanged in the event of an opposing incident flow onto the damping valve device.

It can also be derived from FIG. 2 that the stop 49 is designed to be adjustable. A contour shown in dashed lines shows the stop 49 in one possible initial position. The adjustable stop 49 is formed by an edge 69 on the carrier side. Preferably, the stop 49 is designed in one piece with a cover or one of the cover discs 51; 53 of the valve carrier 25.

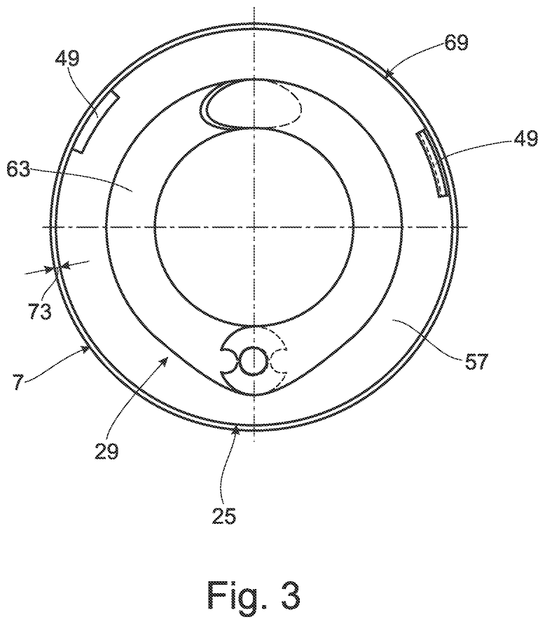

The stop 49 on the carrier side can be fully closed over the circumference, but can also be designed in a segment-like manner, as FIG. 3 shows. In this exemplary embodiment, the stop 49 is adjusted as a function of a defined diameter of the valve element 29, by the valve carrier 25 being at least partially plastically deformed by a re-shaping tool 71. The diameter of the flow guiding surface 33 represents a reference value when the stop 49 is adjusted. A dashed-dotted line symbolizes the optimal widened position of the valve element 29 in which a minimum throttle cross section 39 min is present. With a tool, not shown, which is introduced into the pressure space, or on a flow bench, the valve element 29 is correspondingly brought into the maximum permitted widened position with a minimum throttle cross section 39 min. In this state, the stop 49 is re-shaped from an initial position, shown in dashed lines, for example, into a target position. It is also possible to make use of the fact that before the start of the re-shaping process the annular groove 27 of the valve carrier 25 has a height H which is greater than the overall height h of the valve element 29 in order to simplify the mounting of the valve element 29.

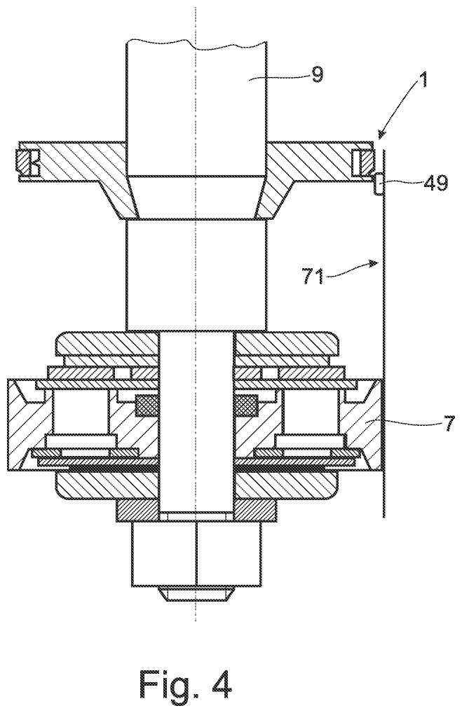

In the embodiment of the damping valve device 1 according to FIG. 4, a solution idea is implemented that can be used independently of the method for adjusting the stop 49. The stop 49 is oriented as a function of the radial position of a piston 7 on the piston rod 9, the damping valve device 1 also being at least indirectly fastened thereto. To this end, by way of example, the re-shaping tool 71 is guided up to the piston 7 which thus acts as a frame of reference. The re-shaping tool 71 can be radially supported on the piston 7 for adjusting the stop 49.

The effect of the orientation of the stop 49 on the radial position of the piston 7 relative to the piston rod 9 is shown in FIG. 3. A thin solid line represents the radial position of the piston 7 on the piston rod 9. A visible radial offset 73 is present between the damping valve device 1, in particular the valve carrier 25, and the piston 7. The radial offset 73 can be at least partially compensated by a targeted re-shaping of the segment-like stops 49, by one segment being re-shaped to a considerably greater extent, for example, in the direction of the maximum offset.

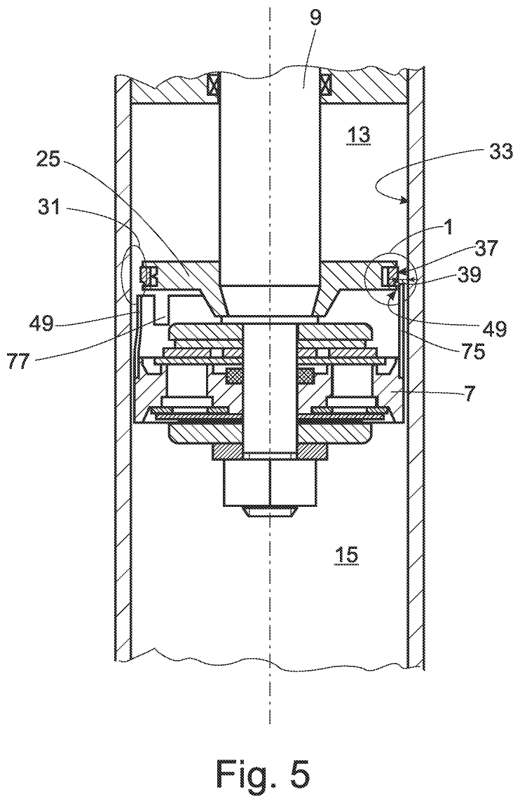

It is intended to be illustrated by FIG. 5 that the stop 49 can also be fastened to the piston 7 for limiting the widening movement of the valve element 29. Thus the valve element 29 is directly centred relative to the radial piston position of the piston rod 9. By way of example, the stop 49 can be formed by a sleeve 75, which is supported on the piston 7 and which can also be further radially deformed. In particular, a segment-like stop 49 provides the advantage that a through-cross section 77 is present between the segments for the connection between the damping valves on the piston 7 and the damping valve device 1.

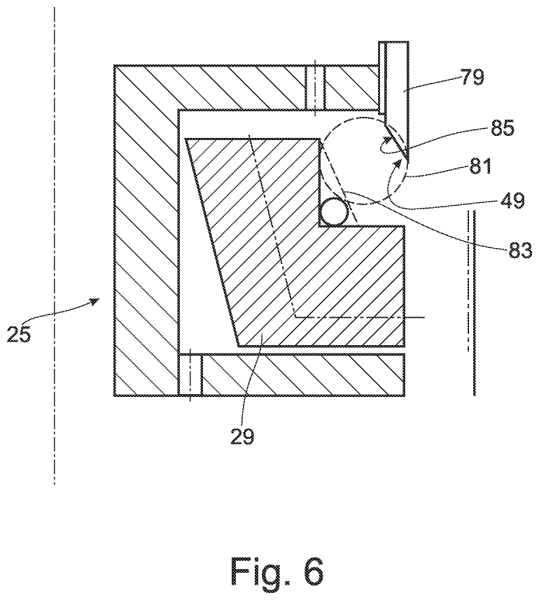

FIG. 6 shows by way of example that the stop 49 can be formed by an axially adjustable stop sleeve 79. In this specific embodiment, the stop sleeve 79 is designed as a screw sleeve. Alternatively, an interference fit can also be present between the stop sleeve 79 and the valve carrier 25, via which the axial operating forces can be assisted. At least one contact surface region 81 of the valve element 29 with the adjustable stop 49 has a conical surface 83; 85 so that an axial adjusting movement of the stop sleeve 79 leads to a change in the maximum widened position of the valve element 29.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1. A damping valve device comprising:
a valve element which can be changed in terms of diameter;
a flow guiding surface;
an adjustable stop; and
a valve carrier having a circumferential annular groove in which the valve element forms a throttle point together with the flow guiding surface,
wherein the throttle point transitions from a through-flow position into a throttled position as a function of a flow rate of a damping medium, and at a same time a maximum widened position of the valve element is limited, which is determined by the adjustable stop.

2. The damping valve device according to claim 1, wherein the adjustable stop is oriented as a function of a radial position of a piston on a piston rod, the damping valve device being at least indirectly fastened on the piston rod.

3. The damping valve device according to claim 1, wherein the adjustable stop is formed by an edge on a carrier side of the valve carrier.

4. The damping valve device according to claim 3, wherein the adjustable stop is configured in a segment-like manner.

5. The damping valve device according to claim 3, wherein the adjustable stop is configured in one piece with a cover of the valve carrier.

6. The damping valve device according to claim 2, wherein the adjustable stop is fastened to the piston.

7. The damping valve device according to claim 6, wherein the adjustable stop is formed by a sleeve supported on the piston.

8. The damping valve device according to claim 1, wherein the adjustable stop is formed by a stop sleeve that is axially adjustable.

9. The damping valve device according to claim 8, wherein the stop sleeve is a screw sleeve.

10. The damping valve device according to claim 8, wherein at least one contact surface region of the valve element with the adjustable stop has a conical surface.

11. A method for producing a damping valve device having a valve element which can be changed in terms of diameter, a flow guiding surface, an adjustable stop, and a valve carrier having a circumferential annular groove in which the valve element forms a throttle point together with the flow guiding surface, comprising:
adjusting the adjustable stop as a function of a defined diameter of the valve element; and
at least partially plastically deforming the valve carrier by a re-shaping tool.

12. The method for producing the damping valve device according to claim 11, wherein before a start of a re-shaping process the circumferential annular groove has a height H, which is greater than an overall height h of the valve element.

13. The method for producing the damping valve device according to claim 12, wherein the re-shaping tool is supported on a piston for adjusting the adjustable stop.
